(19) United States
(12) Patent Application Publication
(10) Pub. No.: US 2006/0174879 A1
(43) Pub. Date: Aug. 10, 2006

(54) Oxygen hose fire barrier

(75) Inventors: Dennis Ashford, Birmingham (GB); Nicholas J. Macmillan, Greensburg, PA (US); Donald W. Hunter, Somerset, PA (US)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: Sunrise Medical HHG Inc., Longmont, CO (US)

(21) Appl. No.: 11/052,354

(22) Filed: Feb. 7, 2005

(51) Int. Cl. A62B 17/04; A62B 17/00

(52) U.S. Cl. 128/201.22; 128/201.29; 128/202.24; 128/202.27

(57) ABSTRACT

A fire barrier for preventing fire from advancing along an oxygen delivery hose towards a source of oxygen. The fire barrier includes a non-combustible tube having hose fittings attached to opposite ends of the tube. The fire barrier is inserted in series in the oxygen delivery hose. The hose fittings are sufficiently spaced apart to prevent a fire advancing along the hose to the barrier from igniting the hose attached to the opposite end of the fire barrier. Supports may be provided for supporting the hose fittings above a floor or other support surface for the oxygen barrier.

### CROSS-REFERENCE TO RELATED APPLICATIONS

Not Applicable.

### STATEMENT REGARDING FEDERALLY SPONSORED RESEARCH OR DEVELOPMENT

Not Applicable.

### TECHNICAL FIELD

The invention relates to home medical oxygen systems and more particularly to a fire barrier for preventing fire started, for example, by a patient receiving supplemental oxygen who smokes, from advancing along an oxygen supply hose.

### BACKGROUND OF THE INVENTION

Many people who require supplemental oxygen for medical purposes are smokers. Because tobacco can be addictive, these individuals may have difficulty in stopping their smoking habit. When a patient goes on supplemental oxygen, he or she is told that they cannot smoke while they are on oxygen due to a high fire risk. If a patient smokes while receiving supplemental oxygen through a nasal cannula, there is a risk that the cigarette can flare up and ignite the plastic material from which the nasal cannula is constructed. The oxygen supply tube can then start rapidly burning from the cannula end towards the oxygen source. The oxygen supply tube can burn like a fuse due to the high concentration of oxygen flowing through the tube. If the oxygen source is an oxygen concentrator, the oxygen concentration may be up to about 95%. If the oxygen is bottled or liquid oxygen from a commercial source, it will have a higher concentration.

In some countries such as England, oxygen delivery systems may be built into the home for a patient. An oxygen concentrator is placed at a fixed location in the home and is connected to a permanently installed distribution system which includes pipes installed in the walls with outlets in different rooms. When the patient moves from one room to another, the hose which delivers oxygen to the nasal cannula is disconnected from a wall fitting and is attached to a wall fitting in the new room. If the oxygen supply tube should catch on fire, it will rapidly burn across the room to the wall fitting and can set the wall on fire.

### BRIEF SUMMARY OF THE INVENTION

The invention is directed to an oxygen hose fire barrier which will stop the flame advancement along an oxygen supply tube. The fire barrier is inserted in series in the oxygen supply tube between the patient and the oxygen source. When the oxygen supply tube is connected to a wall connector, the fire barrier will stop the fire from moving down the supply tube to the wall and setting the wall on fire.

Various objects and advantages of the invention will become apparent from the following detailed description of the invention and the accompanying drawings.

### BRIEF DESCRIPTION OF THE DRAWINGS

FIG. 1 is a fragmentary perspective view of two rooms in a home showing an oxygen distribution system delivering medical oxygen from a source in one room to a patient located in a different room according to the prior art;

FIG. 2 is an elevational view of an oxygen hose fire barrier according to one embodiment of the invention;

FIG. 3 is an enlarged fragmentary cross sectional view showing details of an exemplary barbed fitting at one end of the fire barrier of FIG. 2; and

FIG. 4 is a perspective view of a modified embodiment of an oxygen hose fire barrier according to the invention.

### DETAILED DESCRIPTION OF THE INVENTION

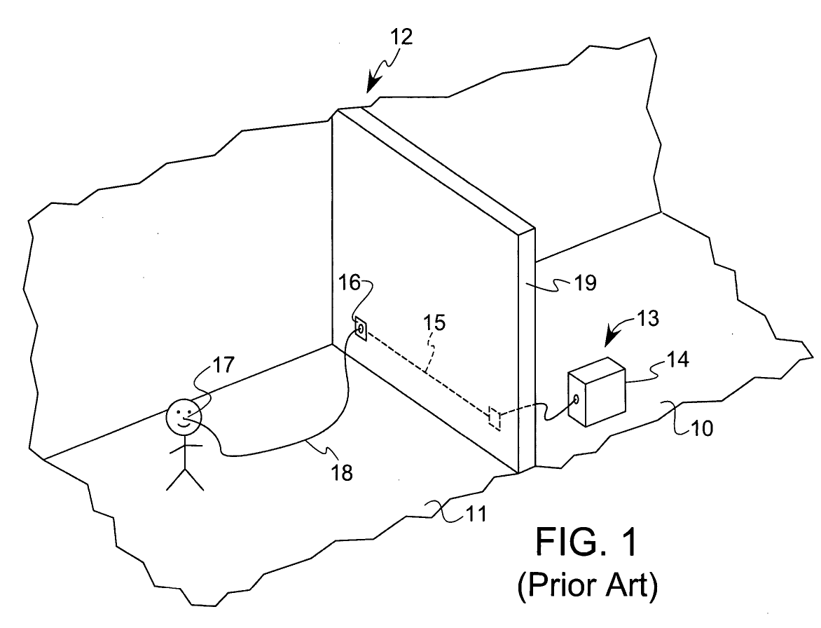

FIG. 1 of the drawings shows a fragmentary portion of two rooms 10, 11 in a home 12. The home 12 is provided with an oxygen delivery system 13 of a type sometimes installed, for example, in homes in England. The oxygen delivery system 13 comprises an oxygen source 14 located in the room 10 which is connected to plumbing 15 installed in walls 19 to an oxygen wall outlets 16, as shown in the room 11. One or more wall oxygen outlets 16 may be installed in each room which the person requiring oxygen will use.

A patient 17 receiving supplemental medical oxygen is shown in room 11. A conventional nasal cannula (not shown) is connected through an oxygen delivery hose or tube 18 to the oxygen wall outlet 16. Preferably, the hose 18 is of sufficient length to allow the patient 17 to move freely around the room 11. When the patient 17 wants to move to another room, the hose 18 is unplugged from the wall outlet 16, the patient moves to the next room and plugs the hose 18 into an oxygen wall outlet in that room.

In an alternate embodiment used in many countries, oxygen delivery plumbing is not installed in walls. In this case, the patient must either move the oxygen source from room to room, or must be connected to the oxygen source through an oxygen delivery hose 18 of sufficient length to allow the patient sufficient freedom to move between rooms.

If the patient 17 should smoke or otherwise come close to an open flame while on supplemental oxygen, there is a significant increased risk of a fire. It is possible for the oxygen delivery hose 18 to catch on fire. If the oxygen supply tube 18 does catch on fire, the fire will quickly advance along the hose 18 towards the oxygen source. Since the oxygen supply tube will be laying across the floor 20, carpet (not shown) or any other floor covering may be ignited. If the oxygen is supplied from a wall outlet 16, the wall 19 also may be ignited. If the oxygen is supplied from an oxygen concentrator, the housing for the oxygen concentrator may be set on fire.

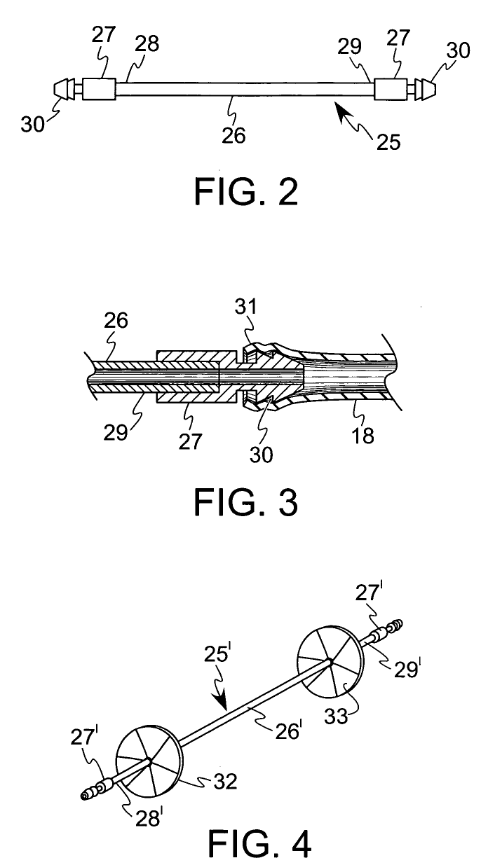

FIGS. 2 and 3 show an oxygen hose fire barrier 25 according to the invention for stopping fire from advancing along an ignited oxygen supply hose 18. The fire barrier 25 generally comprises a non-flammable tube 26 which may be, for example, a length of copper tubing. Barbed fittings 27 are attached to opposite ends 28 and 29 of the tube 26. Each fitting 27 has a barbed end 30 which is sized to receive and hold an end 31 of the oxygen delivery hose 18.

In operation, the oxygen delivery hose 18 of FIG. 1 is cut at a location between the wall outlet 16 and the patient 17 and the fire barrier 25 is inserted in series between the cut hose ends. Thus, the oxygen delivered to the patient 17 will flow through the fire barrier 25. If the hose 18 should become ignited at a location between the fire barrier 25 and the patient 17, fire will advance along the hose 18 until it reaches the fire barrier 25. If combustible materials are present at the fire barrier, the fire will continue to burn, but will not advance along the hose 18 to the wall outlet 16 or other oxygen source. Although carpet or other combustible materials on the floor may be set on fire, the fire barrier 16 will prevent the wall 19 from being quickly set on fire. This can give the patient or others a greater opportunity to put out the fire before the home is set on fire.

FIG. 4 illustrates a modified embodiment of an oxygen hose fire barrier 25′ according to the invention. (Components of the fire barrier 25′ which are the same as for the fire barrier 25 are designated with the prime of the same reference number.) The fire barrier 25′ differs from the fire barrier 25 in that a support 32 is attached to the tube 26′ adjacent the end 28′ and a support 33 is attached to the tube 26′ adjacent the end 29′. The supports 32 and 33 raise the tube 26′ above the floor so that the fittings 27′ will be spaced from any combustible material on the floor, such as carpet. As a consequence, when an ignited hose 18 burns to the fire barrier 25′, burning of any combustible material next to the fire barrier 25′ will not be fed with oxygen discharged from the fire barrier 25′.

It will be appreciated that the illustrated construction of the supports 32 and 33 and that any type of non-combustible support may be provided for supporting the tube 26′ above the floor. It also should be appreciated that only the end of the tube 26′ which is connected through the hose 18 to the patient need be supported above the floor, since an ignited hose will burn to this end.

The length of the tube 26, 26′ is not critical, so long as it is sufficient to prevent fire at an oxygen outlet end of the fire barrier from quickly advancing to the end of the oxygen hose attached from the source to the inlet end of the fire barrier 25, 25′. Preferably, the tube 26, 26′ is of sufficient length so that if combustible material adjacent the oxygen outlet end is ignited, there will be a delay before the fire will reach the other end of the tube 26, 26′ and ignite the oxygen hose connected to the fire barrier.

Barbed fittings 27, 27′ are shown for connecting the ends of the oxygen delivery hose 18 to the fire barrier 25, 25′. These push on fittings are adequate, since the medical oxygen is delivered to the patient at a low pressure. However, it will be appreciated that other known types of hose fittings also may be used to connect the hose to the opposite ends of the fire barrier.

As used herein, the term “oxygen” is intended to include both high purity medical oxygen of the type delivered to a patient is pressurized containers, and oxygen enriched air from an oxygen concentrator.

It will be appreciated that various modifications and changes may be made to the above described preferred embodiment of an oxygen hose fire barrier without departing from the scope of the following claims.

1. An oxygen hose fire barrier adapted for insertion between an end of a first hose which is connected to a source of medical oxygen and an end of a second hose which is connected to deliver oxygen to a patient, said fire barrier comprising a non-combustible tube having first and second spaced ends, a first fitting attached to said first barrier end for receiving the first hose end, a second fitting attached to said second barrier end for receiving the second hose end, and wherein said first and second fittings are sufficiently spaced apart to prevent a fire advancing along the second hose to said fire barrier from igniting the first hose.

2. An oxygen hose fire barrier, as set forth in claim 1, and wherein said first fitting has a barbed end adapted for securing to the first hose end, and said second fitting has a barbed end adapted for securing to the second hose end.

3. An oxygen hose fire barrier, as set forth in claim 2, and further including a support adapted for supporting at least said second fitting above a surface which supports the second hose.

4. An oxygen hose fire barrier, as set forth in claim 3, and wherein said support is adapted for supporting both said first and second fittings above a surface which supports the second hose.

5. An oxygen hose fire barrier, as set forth in claim 4, and wherein said support comprises a first support attached to said tube adapted for supporting said first fitting above a surface which supports the second hose, and a second support attached to said tube adapted for supporting said second fitting above a surface which supports the second hose.

6. A system for delivering medical oxygen a patient comprising a fire barrier having first and second ends, a first hose connected to a source of medical oxygen, said first hose having a first end connected to said first end of said fire barrier, a second hose having a first end connected to deliver oxygen to a patient and having a second end connected to said second end of said fire barrier, and wherein said first and second ends of said fire barrier are sufficiently spaced apart to prevent a fire advancing along the second hose to said fire barrier from igniting the first hose.

7. A system for delivering medical oxygen a patient, as set forth in claim 6, and wherein said fire barrier includes a non-combustible metal tube having a first hose fitting at a first end forming said first fire barrier end and a second hose fitting at a second end forming said second fire barrier end.

8. A system for delivering medical oxygen a patient, as set forth in claim 7, wherein at least a portion of said second hose is supported on a surface, and wherein said fire barrier further includes a support for supporting at least said second fire barrier end above said surface.

9. A system for delivering medical oxygen a patient, as set forth in claim 8, and wherein said support supports both of said first and second fire barrier ends above said surface.
